(19) United States
(12) Patent Application Publication
(10) Pub. No.: US 2003/0121409 A1
(43) Pub. Date: Jul. 3, 2003

(54) System and method for controlling hydraulic flow

(75) Inventors: Stephen V. Lunzman, Chillicothe, IL (US); Larry E. Kendrick, Peoria, IL (US); John T. Reedy, Peoria, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/028,690

(22) Filed: Dec. 28, 2001

(51) Int. Cl. F15B 13/044

(52) U.S. Cl. 91/459

(57) ABSTRACT

A method is provided for controlling hydraulic flow through a valve. The method includes determining a pressure drop across the valve and estimating a flow rate through the valve based on the pressure drop and a displacement of the valve. A command signal to actuate the valve is computed based on a desired flow rate and the estimated flow rate through the valve.

### TECHNICAL FIELD

This invention relates to a system and method for controlling hydraulic flow through a valve. More particularly, the invention is directed to a system and method for controlling hydraulic flow through a valve by monitoring a pressure drop across the valve.

### BACKGROUND

It is well known to use a valve in a hydraulic circuit of a machine, such as an excavator or a loader, to control a hydraulic flow from a pump to a cylinder, a hydraulic motor, or any other device. When an operator of the machine actuates a valve by, for example, moving a lever, pressurized hydraulic fluid flows from the pump to the device through the valve. The amount of the hydraulic flow to the device can be controlled by changing the displacement of a valve spool located in the valve.

Typically, a valve used to control hydraulic flow is equipped with a valve spool having metering slots that control flow through the valve. The valve may control various types of hydraulic flows, such as a flow from a pump to a cylinder or a cylinder to a reservoir tank. In a valve used to control hydraulic flow, it is known to use a pressure compensator spool to maintain a constant hydraulic flow through the valve as the pump and the load pressures vary. The pressure compensator spool, however, does not allow flexible control over the hydraulic flow across the valve. Also, the pressure compensator spool does not provide the hydraulic circuit with damping, and the spool cannot be electrically adjusted. Moreover, the pressure compensator spool increases the manufacturing cost and equipment size. Thus, a hydraulic circuit with a pressure compensator spool is not always a desirable alternative.

A hydraulic flow control system without a pressure compensator spool is disclosed in U.S. Pat. No. 5,218,820. This hydraulic control system controls a valve by using cylinder pressure sensors. The disclosed system, however, does not have accurate flow control capabilities and it does not allow accurate flow control through the valve.

Thus, it is desirable to provide a hydraulic flow control system that provides accurate and flexible control of the hydraulic flow through the valve, is relatively inexpensive to manufacture, and is compact in size. The present invention is directed to solving one or more of the problems associated with prior art designs.

### SUMMARY OF THE INVENTION

In one aspect, a method is provided for controlling hydraulic flow through a valve. The method includes determining a pressure drop across the valve, estimating a flow rate through the valve based on the pressure drop and a displacement of the valve, and computing a command signal to actuate the valve based on a desired flow rate and the estimated flow rate through the valve.

In another aspect, a system is provided for controlling hydraulic flow through a valve. The valve has an inlet port and an outlet port and is coupled to an actuator for actuating the valve. The system includes a pressure sensor assembly configured to monitor a pressure drop across the valve and a flow controller coupled to the pressure sensor assembly. The flow controller is configured to estimate a flow rate through the valve based on the pressure drop and a displacement of the valve, and to determine a command signal to the actuator based on the estimated flow rate and a desired flow rate through the valve.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an exemplary embodiment of the invention and together with the description, serve to explain the principles of the invention.

FIG. 1 is a schematic and diagrammatic representation of a hydraulic flow control system according to one exemplary embodiment of the present invention; and

FIG. 2 is a schematic and diagrammatic representation of a process of the hydraulic flow control system of FIG. 1.

### DETAILED DESCRIPTION

Reference will now be made in detail to an exemplary embodiment of the invention, which is illustrated in the accompanying drawings. Wherever possible, the same reference numbers will be used throughout the drawings to refer to the same or like parts.

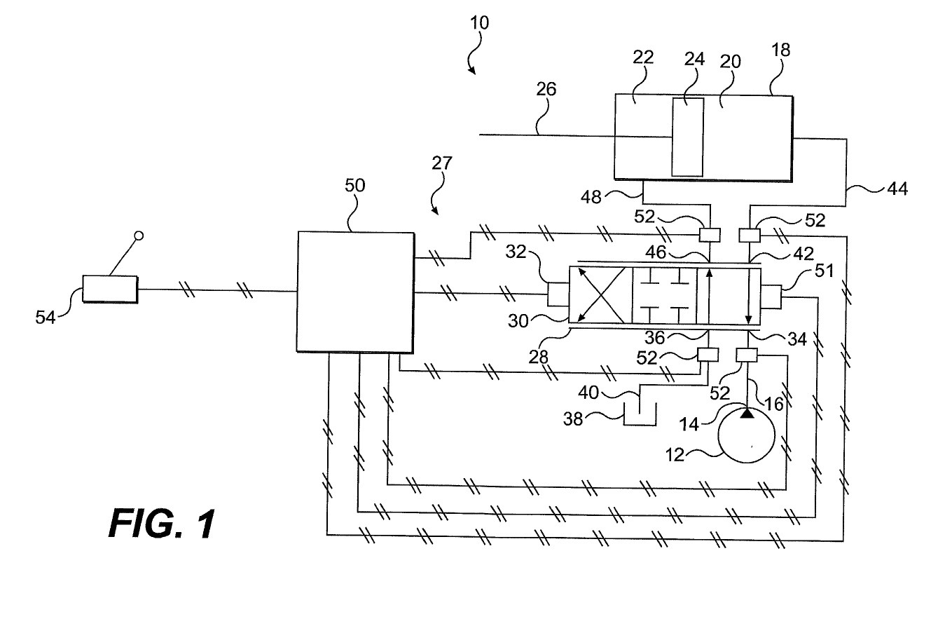

FIG. 1 diagrammatically illustrates a machine having a system for controlling hydraulic flow through a valve according to one exemplary embodiment of the invention. The machine 10 shown in FIG. 1 may be an excavator, a loader, or any other piece of equipment utilizing a hydraulic system to move a load. The machine 10 includes a pump 12, which typically derives power from a motor (not shown in the figure), such as an engine. The pump 12 has a pump outlet port 14 connected to a conduit 16.

In one exemplary embodiment, the machine 10 includes a double-acting cylinder 18. The double-acting cylinder 18 has a pair of actuating chambers, namely a head-end actuating chamber 20 and a rod-end actuating chamber 22. The head-end actuating chamber 20 and the rod-end actuating chamber 22 are separated by a piston 24 having a piston rod 26. The double-acting cylinder 18 may be a hydraulic cylinder or any other suitable implement device used for raising, lowering, or otherwise moving a portion of the machine 10, such as an implement. Though the embodiment is described with respect to a hydraulic cylinder, this invention should not be limited to a cylinder, and the machine 10 may include a hydraulic motor or any other suitable implement.

The machine 10 includes a hydraulic flow control system 27. The hydraulic flow control system 27 has a valve 28 connected to the pressure outlet port 14 of the pump 12 via the conduit 16. The valve 28 has a valve spool 30. In the exemplary embodiment shown in FIG. 1, the valve 28 is a four-way proportional valve. However, the invention is not limited to a four-way proportional valve, and the valve 28 can be any other suitable valve known to those skilled-in-the art. By means of example only, it is contemplated that valve 28 may be an independent metering valve (IMV). As is well known to those skilled in the art, an IMV typically has a plurality of independently operable valves that may be in fluid communication with a pump, a cylinder, a reservoir, and/or any other device present in a hydraulic circuit. The IMV allows independent metering of each of the valves to control hydraulic flow in multiple hydraulic paths. In one exemplary embodiment, the hydraulic flow control system may control each of the independently operable valves in the IMV.

In the disclosed embodiment, the hydraulic flow control system 27 has an actuator 32 to move the valve spool 30 to a desired position to thereby control the hydraulic flow through the valve 28. The displacement of the valve spool 30 changes the flow rate of the hydraulic fluid through the valve 28. The actuator 32 may be a solenoid actuator or any other actuator known to those skilled in the art.

In an exemplary embodiment, the valve 28 has a first port 34 connected to the pump 12 by the conduit 16, a second port 36 connected to a reservoir tank 3 8 by a conduit 40, a third port 42 connected to the head-end actuating chamber 20 of the cylinder 18 by a conduit 44, and a fourth port 46 connected to the rod-end actuating chamber 22 of the cylinder 18 by a conduit 48.

The valve 28 of this exemplary embodiment has a first position, a second position, and a neutral position. In the first position (shown in FIG. 1), the first port 34 and the third port 42 are in fluid communication, and the valve 28 passes the fluid from the pump 12 to the head-end actuating chamber 20 of the cylinder 18. At the same time, the second port 36 and the fourth port 46 are in fluid communication, and the valve 28 exhausts the fluid from the rod-end actuating chamber 22 to the reservoir tank 38.

Alternatively, in the second position (not shown in FIG. 1), the first port 34 and the fourth port 46 are in fluid communication so that the valve 28 passes the fluid from the pump 12 to the rod-end actuating chamber 22. Simultaneously, the second port 36 is in fluid communication with the third port 42 to pass the fluid from the head-end actuating chamber 20 to the reservoir tank 38. The valve spool 30 of the valve 28 can be moved by the actuator 32 to meter the fluid flow through the valve 28, as well as to move the valve 28 between the first position and the second position.

The exemplary hydraulic flow control system 27 also has pressure sensors 52 to monitor an inlet port pressure and an outlet port pressure of the valve 28 to determine a pressure difference or pressure drop across the valve 28. In the embodiment shown in FIG. 1, the pressure sensors 52 are located at each of the conduits 16, 40, 44, 48. When the fluid passes from the pump 12 to the head-end actuating chamber 20, the sensor 52 at the conduit 16 monitors the inlet port pressure and the sensor 52 at the conduit 44 monitors the outlet port pressure. From the pressure readings from the pressure sensors 52 at the conduits 16, 44, the pressure drop across the valve 28 for the pump-to-cylinder flow can be determined. The sensors 52 at the conduits 40, 48 may also monitor the pressure drop across the valve 28 for the cylinder-to-tank flow, if so desired.

When the fluid passes from the pump 12 to the rod-end actuating chamber 22, the sensors 52 at the conduits 16, 48 monitor the pressure drop across the valve 28 for the pump-to-cylinder flow. In this case, the sensor 52 at the conduit 16 monitors the inlet port pressure and the sensor 52 at the conduit 48 monitors the outlet port pressure. The sensors 52 at the conduits 40, 44 may also monitor the pressure drop across the valve 28 for the cylinder-to-tank flow.

The locations and number of the sensors 52 of the present invention are not limited to the specific arrangement illustrated in FIG. 1. The pressure sensors 52 can be placed at any location suitable to determine a desired pressure drop across the valve 28. One skilled in the art will appreciate that any pressure sensor assembly capable of ascertaining a pressure drop across valve 28 may be utilized.

The exemplary hydraulic flow control system 27 includes a controller 50 electrically coupled to the actuator 32 and the pressure sensors 52. In the exemplary embodiment, the controller 50 receives pressures readings, Pₚᵤₘₚ and P_{load}, from the pressure sensors 52 at the pump side and the cylinder side, respectively, of the valve 28. The controller 50 also sends an electrical command signal, i_{cmd}, to the actuator 32. In response to the electrical command signal, the actuator 32 applies a varying force to controllably move the valve spool 30 to a desired displacement to control the hydraulic flow through the valve 28.

An operator input 54, such as a lever, may be electrically connected to the controller 50, and a hydraulic flow rate command, Q_{cmd}, may be sent from the operator input 54 to the controller 50. By manipulating the operator input 54 to control the hydraulic flow rate through the valve 28, the operator can control the cylinder 18 in a desired manner.

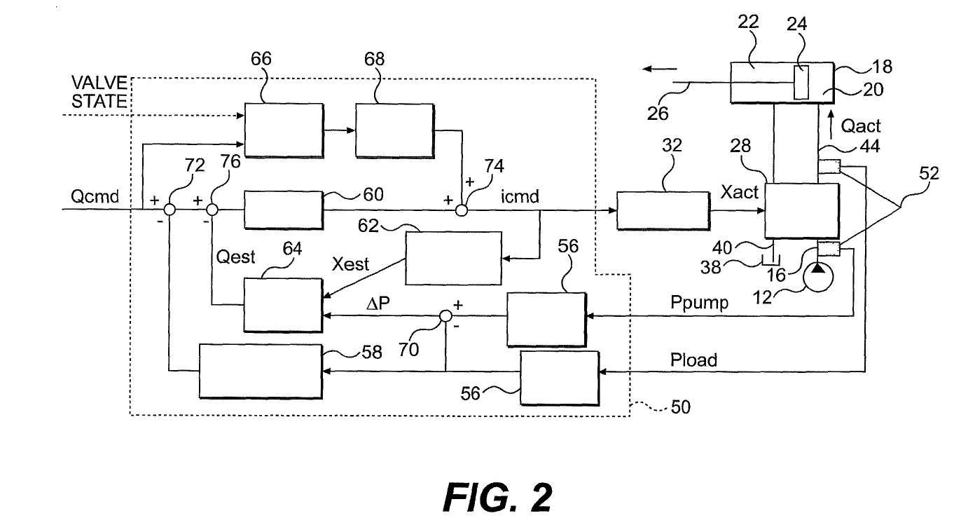

FIG. 2 illustrates a schematic and diagrammatic representation of a process of the hydraulic flow control system of FIG. 1 for a pump-to-cylinder flow. The hydraulic flow control system 27 has the pressure sensors 52 at the conduits 16, 44. As described above, however, the number and locations of the pressure sensors 52 can be readily varied. As shown in FIG. 2, the pressure sensor 52 at the conduit 16 monitors the inlet port pressure, and the pressure sensor 52 at the conduit 44 monitors the outlet port pressure.

In the embodiment shown in FIG. 2, the controller 50 includes noise filters 56. The pump pressure reading and the load pressure reading, Pₚᵤₘₚ and P_{load}, from the pressure sensors 52 may be fed to one of the noise filters 56. The noise filters 56 remove unwanted noise in the pressure readings, such as pressure oscillation and vibration, and stabilize the pressure readings, Pₚᵤₘₚ and P_{load}. The controller 50 may also include a high-pass filter 58, a limit function unit, and a compensator 60. The high-pass filter 58 adds damping to the hydraulic circuit connecting the pump 12, the cylinder 18, and the reservoir tank 38. The limit function unit limits the high end of the output from the high-pass filter 58 to prevent unwanted closing of the valve 28. In one exemplary embodiment, the high end limit may be determined by the hydraulic flow rate command, Q_{cmd}. The compensator 60 provides an adjustable gain to its input to improve accuracy of a feedback loop process and adds dynamics to the process. The compensator 60 may be designed to provide an appropriate gain to the hydraulic flow control system 27 so that the system does not become unstable. One skilled in the art can readily determine how much gain the compensator 60 should provide to improve the feedback accuracy. The compensator 60 may be a proportional-integral type compensator or any other type suitable for improving stability, response, or accuracy of the electrical signal, i_{cmd}.

The controller 50 may include an actuator map 62 and a spool map 64 stored in a memory. The actuator map 62 contains the relationship between the electrical command signal, i_{cmd}, to the actuator 32 and the displacement or position of the valve spool 30. This relationship may be determined from lab tests or a test run prior to the operation of the system. Using the actuator map 62, the displacement of the valve spool 30 can be estimated from a value of the electrical command signal, i_{cmd}. In another embodiment, the hydraulic flow control system 27 may have a spool position sensor 51 that determines the actual position of the valve spool 30, X_{act}, in place of the actuator map 62. The spool position sensor 51 may be an optical sensor or any other suitable sensor capable of sensing the position of the spool valve 30. Because the displacement of the valve spool 30 is not estimated in this alternative embodiment, the accuracy of the hydraulic flow control may be improved.

The spool map 64 contains the relationship between the displacement of the valve spool 30, the pressure drop across the valve 28 (ΔP), and a hydraulic flow rate across the valve 28. These values can be determined during either a test run of the hydraulic flow control system 27 or a lab test. In addition to the above values, the spool map 64 may include the temperature of the hydraulic fluid to improve accuracy of the system. The hydraulic flow control system 27 may have a temperature sensor to monitor the temperature of the hydraulic fluid. In the embodiment shown in FIG. 2, the spool map 64 estimates the flow rate through the valve 28, Qₑₛₜ, from the estimated actuator displacement, Xₑₛₜ, and the pressure drop across the valve 28, ΔP. In another embodiment, the spool map 64 and the actuator map 62 may be combined into a single map.

The controller 50 also has an offset logic 66 and a rate limiter 68. The offset logic 66 determines an offset of the valve 28 that is used to bias the valve 28 to account for its dead band, leakage, etc. The offset logic 66 receives the hydraulic flow rate command, Q_{cmd}, and may also receive valve state information, which indicates the operating status of the valve 28, such as closed, metering, etc.

The rate limiter 68 is coupled to the offset logic 66. The rate limiter 68 reduces an effect of applying a step change in the offset of the valve 28 and acts to smooth changes due to the offset. The rate limiter 68 may be a first order low-pass filter or any other filter capable of smoothing the effect of the offset changes.

Industrial Applicability

Referring to FIG. 2, the pressure sensors 52 monitor the inlet port and outlet port pressures, which are the pressure at the pump side and the cylinder side, respectively. Each of the pressure readings at the pump side and the cylinder side, Pₚᵤₘₚ and P_{load}, is fed to the corresponding noise filter 56. The noise filters 56 remove noise and stabilize the pressure readings. At a first subtracting junction 70, the pressure drop across the valve 28, ΔP, is determined by subtracting one pressure reading from the other. The value of ΔP is then fed to the spool map 64.

After being stabilized by the noise filter 56, the pressure reading at the cylinder side, P_{load}, is fed to the high-pass filter 58. The high-pass filter 58 passes high frequencies and attenuates low frequencies. As a result, the high-pass filter 58 adds damping to the hydraulic circuit. When the pressure reading at the cylinder side, P_{load}, is steady, the high-pass filter 58 outputs zero value.

The hydraulic flow rate command, Q_{cmd}, is sent from the operator input 54. At a second subtracting junction 72, the output of the high-pass filter 58 is subtracted from the hydraulic flow rate command, Q_{cmd}, to account for unsteady pressure at the cylinder side.

The hydraulic flow rate command, Q_{cmd}, is also fed to the offset logic 66. The offset logic 66 determines an offset of the valve 28 based on the hydraulic flow rate command and the valve state information. In one embodiment of the present invention, the offset of the valve 28 may be used to preposition the valve spool 30 in anticipation of its motion and to account for effects of the dead band of the valve 28. By accounting for such effects, the hydraulic flow rate command, Q_{cmd}, can be transferred as an immediate hydraulic flow control.

The output from the offset logic 66 is fed to the rate limiter 68. The rate limiter 68 reduces an effect of applying a step change in the offset output from the offset logic 66, and smoothens the effect of the changes due to the offset. The output from the rate limiter 68 is added to the output from the compensator 60 at a summing junction 74.

After being processed at the second subtracting junction 72, the hydraulic flow rate command, Q_{cmd}, is processed at a third subtracting junction 76. At the third subtracting junction 76, the hydraulic flow rate command, Q_{cmd}, is subtracted from the estimated hydraulic flow rate, Qₑₛₜ, determined by the spool map 64. The output from the third subtracting junction 76 is then fed to the compensator 60.

From the hydraulic flow rate command processed through the second and third subtracting junctions 72, 76, the compensator 60 computes the electrical signal necessary to achieve the hydraulic flow rate. The output from the rate limiter 68 is then added to the electrical signal computed by the compensator 60 at the summing junction 74 and fed to the actuator 32 as the electrical command signal, i_{cmd}, to manipulate the valve spool 30.

The electrical command signal, i_{cmd}, from the summing junction 74 is also fed to the actuator map 62. From the electrical command signal, the actuator map 62 estimates the displacement of the actuator 32, and outputs the estimated actuator displacement, Xₑₛₜ.

The estimated actuator displacement, Xₑₛₜ, and the pressure drop across the valve 28, ΔP, are fed to the spool map 64, and the spool map 64 estimates the hydraulic flow rate through the valve 28 and outputs the estimated hydraulic flow rate, Qₑₛₜ, to be fed back to the hydraulic flow rate command, Q_{cmd}, defining a closed-loop electric current driver and a closed-loop spool position control.

Therefore, the present invention provides a hydraulic flow control system that provides accurate control of the hydraulic flow through the valve. Moreover, the hydraulic flow control system is relatively inexpensive to manufacture and is compact in size. The disclosed hydraulic flow control system can provide accurate and flexible control of hydraulic flow in a variety of work machines.

It will be apparent to those skilled in the art that various modifications and variations can be made in the valve flow control system and method of the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for controlling hydraulic flow through a valve, comprising:
determining a pressure drop across the valve;
estimating a flow rate through the valve based on the pressure drop and a displacement of the valve; and
computing a command signal to actuate the valve based on a desired flow rate and the estimated flow rate through the valve.

2. The method of claim 1, wherein the flow rate through the valve is estimated by a spool map.

3. The method of claim 1, wherein the command signal is computed by a closed-loop system.

4. The method of claim 1, further including compensating a difference between the desired flow rate and the estimated flow rate to determine the command signal to actuate the valve.

5. The method of claim 1, wherein the pressure drop across the valve is determined by monitoring an inlet port pressure and an outlet port pressure of the valve.

6. The method of claim 5, wherein the monitored inlet port pressure and outlet port pressure are converted into an inlet port pressure signal and an outlet port pressure signal, and the inlet port pressure signal and the outlet port pressure signal are subjected to a noise filter for stabilization.

7. The method of claim 1, wherein the displacement of the valve is estimated based on a command signal provided to the valve.

8. The method of claim 1, wherein the displacement of the valve is measured by a valve position sensor.

9. The method of claim 1, further including determining a dead band offset of the valve and wherein the valve is actuated based on the desired flow rate and the estimated flow rate through the valve and the offset of the valve.

10. A system for controlling hydraulic flow through a valve, the valve having an inlet port and an outlet port and being coupled to an actuator for actuating the valve, the system comprising:
a pressure sensor assembly configured to monitor a pressure drop across the valve; and
a flow controller coupled to the pressure sensor assembly, the flow controller being configured to estimate a flow rate through the valve based on the pressure drop and a displacement of the valve, and to determine a command signal to the actuator based on the estimated flow rate and a desired flow rate through the valve.

11. The system of claim 10, wherein the flow controller includes a memory unit for storing a spool map to estimate the flow rate.

12. The system of claim 10, wherein the command signal to the actuator is configured to be determined by a closed-loop system.

13. The system of claim 10, wherein the flow controller includes a compensator for compensating a difference between the desired flow rate and the estimated flow rate to determine the command signal to the actuator.

14. The system of claim 10, wherein the pressure sensor assembly includes first and second pressure sensors for monitoring pressure at the inlet and outlet ports of the valve, respectively, the flow controller being coupled to the first and second pressure sensors for monitoring a pressure drop across the valve.

15. The system of claim 14, wherein the flow controller includes a noise filter to stabilize the monitored pressure signals at the inlet port and the outlet port of the valve.

16. The system of claim 10, wherein the flow controller includes a memory unit for storing an actuator map to estimate the displacement of the valve based on the command signal provided to the actuator.

17. The system of claim 10, further including a valve position sensor coupled to the controller for sensing the displacement of the valve.

18. The system of claim 10, wherein the flow controller includes an offset logic unit for determining a dead band offset of the valve.

19. The system of claim 18, wherein the command signal is determined based on the desired flow rate and estimated flow rate through the valve, and the dead band offset of the valve.

20. A machine for moving a load, comprising:
a pump;
a hydraulic actuator in fluid communication with the pump;
an independent metering valve in fluid communication with the pump and the hydraulic actuator; and
a hydraulic flow control system coupled to the independent metering valve for controlling a hydraulic flow through the valve, the system including:
a pressure sensor assembly configured to monitor a pressure drop across the valve; and
a flow controller coupled to the pressure sensor assembly, the flow controller being configured to estimate a flow rate through the valve based on the pressure drop and a displacement of the valve, and to determine a command signal to the actuator based on the estimated flow rate and a desired flow rate through the valve.
